(19) United States
(12) Patent Application Publication
(10) Pub. No.: US 2025/0047006 A1
(43) Pub. Date: Feb. 6, 2025

(54) ADJUSTABLE FREQUENCY SELECTIVE SURFACE STRUCTURE

(71) Applicant: BEIHANG UNIVERSITY, Haidian District, Beijing (CN)

(72) Inventors: Jinzu JI, Haidian District, Beijing (CN); Peilin HUANG, Haidian District, Beijing (CN); Jiayi ZHANG, Haidian District, Beijing (CN)

(21) Appl. No.: 18/727,227

(22) PCT Filed: Jan. 9, 2023
(86) PCT No.: PCT/CN2023/071320

§ 371 Date: Jul. 8, 2024

(30) Foreign Application Priority Data
Nov. 9, 2021 (CN) 202111320455.8

(51) Int. Cl. H01Q 15/00; H01Q 1/42

(52) U.S. Cl. CPC H01Q 15/002; H01Q 1/425

(57) ABSTRACT

Provided is a tunable frequency selective surface (FSS) structure, including a dielectric substrate and a square resonant component arranged on the dielectric substrate. The square resonant component includes a plurality of perforated square resonant units arranged in a matrix. The perforated square resonant units each include two identical square perforated metal patches arranged in a mirror image relation, and a varactor diode arranged between the two square perforated metal patches. In the square resonant component, the varactor diodes in the perforated square resonant units in the same row are arranged in a same direction, and the varactor diodes in the perforated square resonant units in adjacent rows are arranged in opposite directions. The present application can achieve the continuous tunable performance of a stopband in a specific frequency band.

The present application claims priority to the Chinese Patent Application No. 202111320455.8, filed with China National Intellectual Property Administration (CNIPA) on 9 Nov. 2021 and entitled “TUNABLE FREQUENCY SELECTIVE SURFACE STRUCTURE”, which is incorporated herein by reference in its entirety.

### TECHNICAL FIELD

The present disclosure relates to the technical field of microwaves, and in particular, to a tunable frequency selective surface structure.

### BACKGROUND

A frequency selective surface (FSS) is composed of a large number of metal unit resonant components regularly arranged on a dielectric substrate or open slot units periodically arranged on a metal screen. The shape of the units, the arrangement of the units, and the electrical properties of the dielectric affect the frequency selection characteristics of the FSS. The FSS has selective characteristics for electromagnetic waves with different operating frequencies, different polarization modes and different incident angles. Due to the spatial filtering characteristics, the FSS is widely applied to military and wireless communication systems.

The FSS is often applied in the fields of aircraft stealth, hybrid radome stealth, electromagnetic compatibility and electromagnetic shielding. The main principle is to design a required frequency band on a passband of the FSS, and design a frequency band that is prone to electromagnetic interference on a stopband of the FSS, thereby facilitating the transmission and reception of signals and the normal operation of equipment. From the perspective of stealth, the low radar cross-section shape is convenient to scatter enemy detection signals into the surrounding space, greatly weakening echoes in the detection direction while not affecting normal communications of own party, thereby improving the stealth and anti-interference performance of the aircraft. An ideal FSS has low loss in the passband and the characteristic of quickly rolling off into the stopband on the outer side of the passband, and for the transmittance of the stopband, the lower the better.

The FSS has a profound impact on the development of weapon systems. The conventional FSS has certain defects, such as poor protection, large size, and non-tunability, and once the structure is designed, the corresponding performance cannot be changed.

### SUMMARY

To solve at least one defect in the background art, the present disclosure provides a tunable frequency selective surface (FSS) structure to achieve the continuous tunable performance of a stopband in a specific frequency band.

To achieve the above objective, the present disclosure provides the following solutions:

A tunable frequency selective surface (FSS) structure, including a dielectric substrate and a square resonant component arranged on the dielectric substrate, where

the square resonant component includes a plurality of perforated square resonant units arranged in a matrix; the perforated square resonant units each include two identical square perforated metal patches, and a varactor diode arranged between the two square perforated metal patches, where the two square perforated metal patches are arranged in a mirror image relation; and

in the square resonant component, the varactor diodes in the perforated square resonant units in the same row are arranged in a same direction, and the varactor diodes in the perforated square resonant units in adjacent rows are arranged in opposite directions.

Optionally, the square perforated metal patches are each provided with three square holes, namely, a first square hole, a second square hole, and a third square hole; and the first square hole and the second square hole are symmetrically arranged on two sides of the third square hole.

Optionally, the first square hole includes two parallel transverse edges and two parallel vertical edges; the second square hole includes two parallel transverse edges and two parallel vertical edges; the third square hole includes two parallel transverse edges and two parallel vertical edges;

one end of a first transverse edge of the third square hole is connected to one end of a first transverse edge of the first square hole, the other end of the first transverse edge of the third square hole is connected to one end of a first transverse edge of the second square hole, and the first transverse edge of the third square hole, the first transverse edge of the first square hole and the first transverse edge of the second square hole are located on a same horizontal line;

one end of a second transverse edge of the third square hole is connected to one end of a second transverse edge of the first square hole, the other end of the second transverse edge of the third square hole is connected to one end of a second transverse edge of the second square hole, and the second transverse edge of the third square hole, the second transverse edge of the first square hole and the second transverse edge of the second square hole are located on a same horizontal line; and

a first vertical edge of the third square hole and a first vertical edge of the first square hole are the same, and a second vertical edge of the third square hole and a first vertical edge of the second square hole are the same.

Optionally, the square perforated metal patches each further include a first extended edge and a second extended edge;

the first extended edge is an edge passing through a first marking end to extend outward, and the second extended edge is an edge passing through a second marking end to extend outward; the first marking end is the other end of the first transverse edge of the first square hole, and the second marking end is the other end of the first transverse edge of the second square hole; and

in the square resonant component, the perforated square resonant units in the same row are connected together through the first extended edge and the second extended edge, such that the varactor diodes in a same row are in parallel connection.

Optionally, the tunable FSS structure further includes a first feed metal wire and a second feed metal wire, where

the first feed metal wire is connected to the other end of a first marking extended edge in the perforated square resonant units in a first column of the matrix, and the second feed metal wire is connected to the other end of a second marking extended edge in the perforated square resonant units in a last column of the matrix;

the perforated square resonant units each include a first square perforated metal patch and a second square perforated metal patch; when the perforated square resonant units are located in odd-numbered rows of the matrix, the first marking extended edge is a first extended edge of the first square perforated metal patch, and when the perforated square resonant units are located in even-numbered rows of the matrix, the first marking extended edge is a first extended edge of the second square perforated metal patch; when the perforated square resonant units are located in odd-numbered rows of the matrix, the second marking extended edge is a second extended edge of the second square perforated metal patch, and when the perforated square resonant units are located in even-numbered rows of the matrix, the second marking extended edge is a second extended edge of the first square perforated metal patch; and

in an operation process, when the varactor diodes have anodes connected to the first square perforated metal patch and cathodes connected to the second square perforated metal patch, when the first feed metal wire is connected to a positive pole of an external power supply, the second feed metal wire is connected to a negative pole of the external power supply, and when the varactor diodes have anodes connected to the second square perforated metal patch and cathodes connected to the first square perforated metal patch, when the first feed metal wire is connected to the negative pole of the external power supply, the second feed metal wire is connected to the positive pole of the external power supply.

Optionally, the transverse edges of the first square hole and the transverse edges of the second square hole are all 1 mm long; the transverse edges of the third square hole are 4 mm long; the vertical edges of the first square hole and the vertical edges of the second square hole are all 4.3 mm long; and the vertical edges of the third square hole are 3.8 mm long.

Optionally, the varactor diodes have a capacitance range of 0.3-2.22 pF; and the varactor diodes have an on-load voltage range of 0-20 V.

Optionally, the perforated square resonant units each have dimensions of 16 mm×10 mm, and the square perforated metal patches each have dimensions of 8 mm×4.6 mm.

Optionally, in the perforated square resonant units, every two of the square perforated metal patches have a gap of 0.4 mm, and the varactor diodes are located at the gaps.

Optionally, the dielectric substrate is an FR4 substrate, and has a thickness of 0.4 mm.

According to specific embodiments provided in the present disclosure, the present disclosure has the following technical effects:

The present disclosure provides a tunable FSS structure, which employs specific metal patterns and varactor diodes to change the equivalent resistance between adjacent square perforated metal patches, thereby achieving continuous adjustability of a stopband in a specific frequency band.

### BRIEF DESCRIPTION OF THE DRAWINGS

To describe embodiments of the present disclosure or technical solutions in the prior art more clearly, the accompanying drawings required in the embodiments are briefly introduced below. Obviously, the accompanying drawings described below are only some embodiments of the present disclosure. Those of ordinary skill in the art can also obtain other accompanying drawings according to these accompanying drawings without creative efforts.

FIG. 1 is a schematic structural diagram of perforated square resonant units of a tunable frequency selective surface (FSS) structure according to the present disclosure;

FIG. 2 is a schematic diagram of an array and a connection mode of a tunable FSS structure according to the present disclosure;

FIG. 3 is an overall schematic diagram of a tunable FSS structure according to the present disclosure;

FIG. 4 is a schematic structural diagram of square perforated metal patches according to the present disclosure;

FIG. 5 is a schematic dimensional diagram of square perforated metal patches according to the present disclosure;

FIG. 6 is a schematic diagram of a reflection characteristic S11 parameter curve of a tunable FSS structure in each frequency band according to the present disclosure; and

FIG. 7 is a schematic diagram of a transmission characteristic S21 parameter curve of a tunable FSS structure in each frequency band according to the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other examples obtained by a person of ordinary skill in the art based on the examples of the present disclosure without creative efforts shall fall within the protection scope of the present disclosure.

An objective of the present disclosure is to provide an FSS structure tunable continuously in multiple wave bands. The present invention achieves the frequency selection function by combining a single-layer perforated square resonant component with varactor diodes, to improve the overall performance of the FSS.

To make the above-mentioned objective, features, and advantages of the present disclosure clearer and more comprehensible, the present disclosure will be further described in detail below in conjunction with the accompanying drawings and specific embodiments.

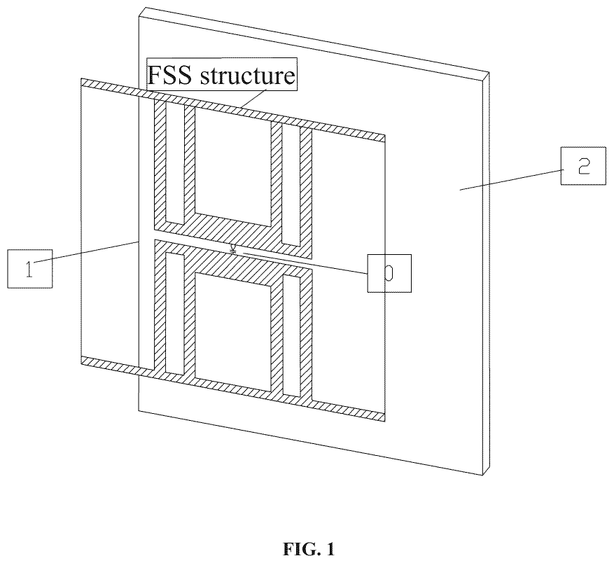

Referring to FIG. 1, the tunable FSS structure provided by the present disclosure includes a perforated square resonant component 1 and a dielectric substrate 2.

The tunable FSS structure is composed of a plurality of periodically distributed units. Specifically, the perforated square resonant component 1 is of a single-layer structure and is arranged on the dielectric substrate 2. The square resonant component 1 includes a plurality of perforated square resonant units arranged in a matrix. The perforated square resonant units each include two identical square perforated metal patches, and a varactor diode 0 arranged between the two square perforated metal patches, where the two square perforated metal patches are arranged in a mirror image relation.

In the square resonant component 1, the varactor diodes 0 in the perforated square resonant units in the same row are arranged in a same direction, and the varactor diodes 0 in the perforated square resonant units in adjacent rows are arranged in opposite directions. Therefore, in an operation process, the varactor diodes in adjacent rows and the same column have opposite on-load voltage directions, and the varactor diodes in the same row and different columns have the same on-load voltage direction.

In the present disclosure, a group of square perforated metal patches arranged in a mirror image relation may be referred to as a unit pattern, then the varactor diodes are arranged in gaps of the unit pattern and are oppositely staggered and connected in parallel.

In the present disclosure, since the square resonant component is of a unit periodic structure, there is a varactor diode at each gap of the unit pattern, then the capacitance between the gaps of the unit pattern can be changed by adjusting the on-load voltage, thereby achieving the tunable function of the FSS in multiple bands. Specifically, the stopband of the tunable FSS structure is continuously tunable within 2-5 GHZ and within 11-12.6 GHZ, and a stable stopband is near 20 GHZ.

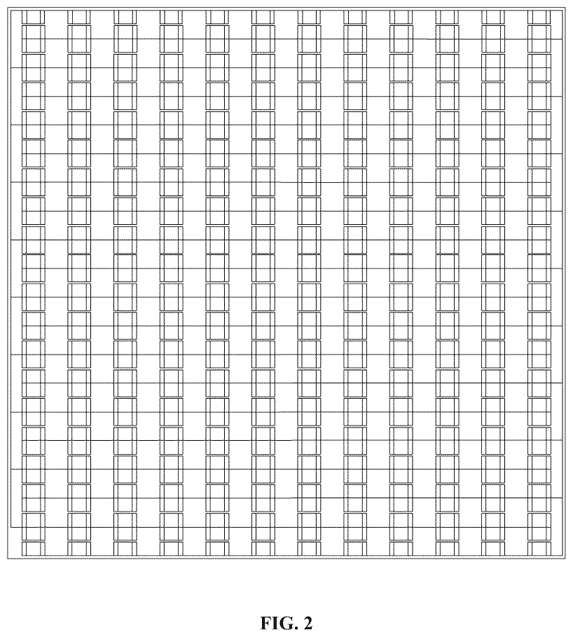

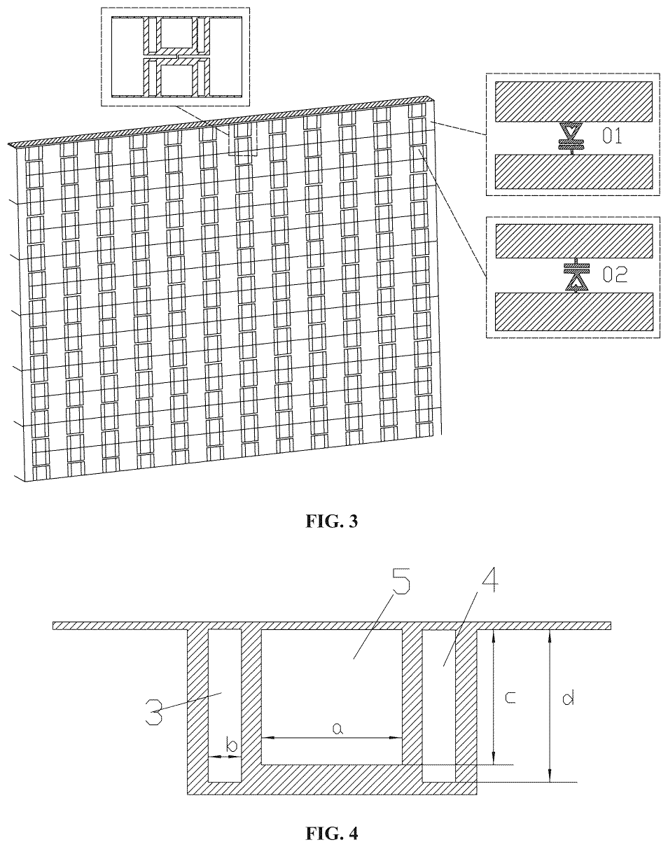

Please referring to FIG. 2 and FIG. 3, the varactor diode 01 and the varactor diode 02 are adjacent to each other and located in different rows, therefore are in different placement directions. Specifically, the placement directions are opposite. In addition, feed metal wires are staggered, such that the entire circuit is connected in parallel to load the equal voltage.

Please referring to FIG. 4, the square perforated metal patches are each provided with three square holes, namely, a first square hole 3, a second square hole 4, and a third square hole 5; and the first square hole 3 and the second square hole 4 are symmetrically arranged on two sides of the third square hole 5. The square perforated metal patches are symmetrical as a whole along the central axis.

The first square hole 3 includes two parallel transverse edges b and two parallel vertical edges d; the second square hole 4 includes two parallel transverse edges b and two parallel vertical edges d; and the third square hole 5 includes two parallel transverse edges a and two parallel vertical edges c.

One end of a first transverse edge of the third square hole 5 is connected to one end of a first transverse edge of the first square hole 3, the other end of the first transverse edge of the third square hole 5 is connected to one end of a first transverse edge of the second square hole 4, and the first transverse edge of the third square hole 5, the first transverse edge of the first square hole 3 and the first transverse edge of the second square hole 4 are located on a same horizontal line; one end of a second transverse edge of the third square hole 5 is connected to one end of a second transverse edge of the first square hole 3, the other end of the second transverse edge of the third square hole 5 is connected to one end of a second transverse edge of the second square hole 4, and the second transverse edge of the third square hole 5, the second transverse edge of the first square hole 3 and the second transverse edge of the second square hole 4 are located on a same horizontal line; and a first vertical edge of the third square hole 5 and a first vertical edge of the first square hole 3 are the same, and a second vertical edge of the third square hole 5 and a first vertical edge of the second square hole 4 are the same.

Furthermore, the square perforated metal patches each further include a first extended edge and a second extended edge.

The first extended edge is an edge passing through a first marking end to extend outward, and the second extended edge is an edge passing through a second marking end to extend outward; the first marking end is the other end of the first transverse edge of the first square hole, and the second marking end is the other end of the first transverse edge of the second square hole.

In the square resonant component, the perforated square resonant units in the same row are connected together through the first extended edge and the second extended edge, such that the varactor diodes in a same row are in parallel connection.

On this basis, the tunable FSS structure provided by the present disclosure further includes a first feed metal wire and a second feed metal wire. The first feed metal wire is arranged on one side of the square perforated metal patches in parallel, and the second feed metal wire is arranged on the other side of the square perforated metal patches in parallel.

The first feed metal wire is connected to the other end of a first marking extended edge in the perforated square resonant units in a first column of the matrix, and the second feed metal wire is connected to the other end of a second marking extended edge in the perforated square resonant units in a last column of the matrix, where the square perforated metal patches and the feed metal wires are all made of pure copper.

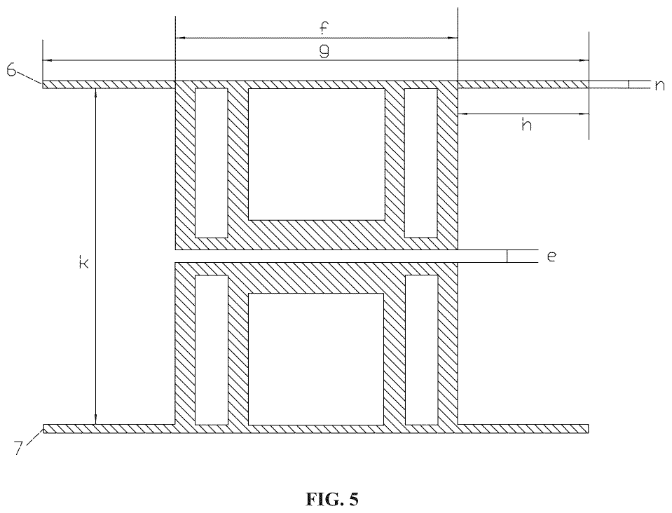

Please referring to FIG. 5, the perforated square resonant units each include a first square perforated metal patch 6 and a second square perforated metal patch 7 which are arranged in a mirror image relation; when the perforated square resonant units are located in odd-numbered rows of the matrix, the first marking extended edge is a first extended edge of the first square perforated metal patch 6, and when the perforated square resonant units are located in even-numbered rows of the matrix, the first marking extended edge is a first extended edge of the second square perforated metal patch 7; when the perforated square resonant units are located in odd-numbered rows of the matrix, the second marking extended edge is a second extended edge of the second square perforated metal patch 7, and when the perforated square resonant units are located in even-numbered rows of the matrix, the second marking extended edge is a second extended edge of the first square perforated metal patch 6.

In an operation process, when the varactor diodes have anodes connected to the first square perforated metal patch and cathodes connected to the second square perforated metal patch, when the first feed metal wire is connected to a positive pole of an external power supply, the second feed metal wire is connected to a negative pole of the external power supply, and when the varactor diodes have anodes connected to the second square perforated metal patch and cathodes connected to the first square perforated metal patch, when the first feed metal wire is connected to the negative pole of the external power supply, the second feed metal wire is connected to the positive pole of the external power supply, such that the varactor diodes in adjacent rows and the same column have opposite on-load voltage directions, and the varactor diodes in the same row and different columns have the same on-load voltage direction. Moreover, by changing the voltage value of the external power supply and tuning the on-load voltage, the equivalent capacitance parameter between the first square perforated metal patch 6 and the second square perforated metal patch 7 is changed, thereby tuning a resonant point on the FSS.

The first square hole 3 and the second square hole 4 each have dimensions of 1 mm×4.3 mm, and the third square hole 5 each have dimensions of 4 mm×3.8 mm. specifically, the transverse edges b of the first square hole 3 and the transverse edges b of the second square hole 4 are all 1 mm long; the transverse edges a of the third square hole 5 are 4 mm long; the vertical edges d of the first square hole 3 and the vertical edges d of the second square hole 4 are all 4.3 mm long; and the vertical edges c of the third square hole 5 are 3.8 mm long.

In FIG. 5, f=8 mm, g=16 mm, h=4 mm, k=9.6 mm, and n=0.2 mm.

In the present disclosure, the perforated square resonant units each have dimensions of 16 mm×10 mm, the square perforated metal patches each have dimensions of 8 mm×4.6 mm, and partial wire width of the feed metal wires is 0.2 mm.

In the present disclosure, in the perforated square resonant units, every two of the square perforated metal patches have a gap e of 0.4 mm, and the varactor diodes are located at the gaps.

In the present disclosure, the dielectric substrate 2 is an FR4 substrate, and has a thickness of 0.4 mm.

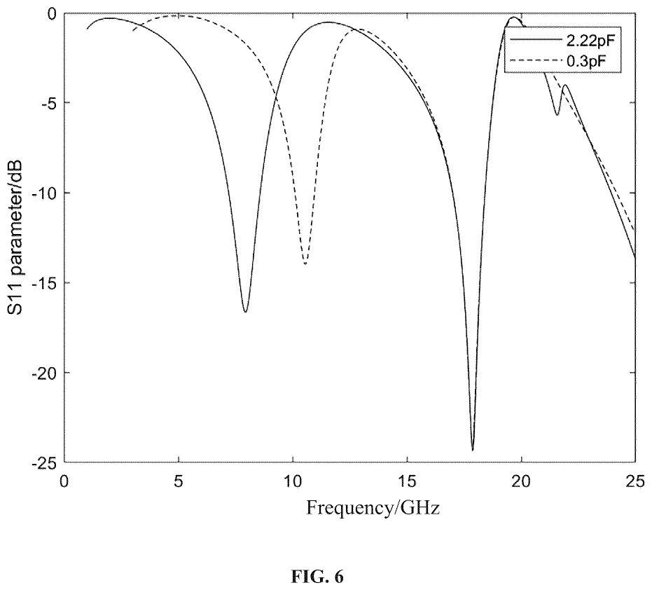

FIG. 6 is a schematic diagram of a reflection characteristic S11 parameter curve of a tunable FSS in each frequency band according to the present disclosure. By changing the on-load voltage within 0-20 V, the resonant frequency can be continuously tuned within 8-10.6 GHz, and is stable and unchanged near 18 GHz. The reflection coefficient in a frequency band of 8-10.6 GHz is about-15 dB, and the reflection coefficient at 18 GHz is about-25 dB.

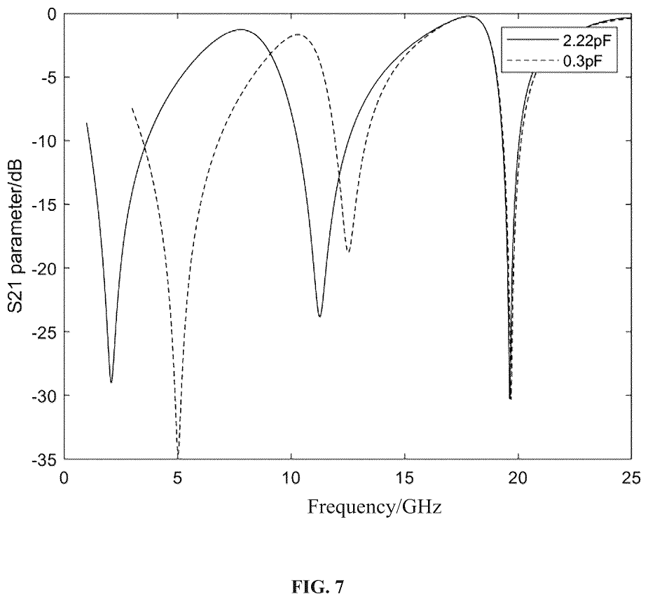

FIG. 7 is a schematic diagram of a transmission characteristic S21 parameter curve of a tunable FSS in each frequency band according to the present disclosure. By changing the on-load voltage within 0-20 V, the resonant frequency can be continuously tuned within 2-5 GHz and 11-12.6 GHz, and is stable and unchanged near 20 GHz. The transmission coefficient in a frequency band of 2-5 GHz is about −29 dB to −35 dB, the transmission coefficient in a frequency band of 11-12.6 GHz is about −18 dB to −24 dB, and the transmission coefficient at 20 GHz is about −30 dB.

According to the simple tunable FSS structure based on the varactor diodes provided by the present disclosure, by loading a bias voltage of 0-20 V, the capacitance parameter of the diodes is tuned within 0.3-2.22 pF, thereby achieving the tunable function of the FSS and improving the overall performance of the FSS. Specifically, the tuning frequency is continuously tunable within 2-5 GHz and within 11-12.6 GHz, and a stable stopband is near 20 GHz.

The embodiments are described herein in a progressive manner. Each embodiment focuses on the difference from another embodiment, and the same and similar parts between the embodiments may refer to each other.

Specific examples are used herein for illustration of the principles and embodiments of the present disclosure. The description of the foregoing embodiments is used to help understand the method of the present disclosure and the core principles thereof. In addition, those of ordinary skill in the art can make various modifications in terms of specific embodiments and scope of application in accordance with the teachings of the present disclosure. In conclusion, the content of the description shall not be construed as limitations to the present disclosure.

1. A tunable frequency selective surface (FSS) structure, comprising:
a dielectric substrate and a square resonant component arranged on the dielectric substrate, wherein
the square resonant component comprises a plurality of perforated square resonant units arranged in a matrix;
the perforated square resonant units each comprise two identical square perforated metal patches arranged in a mirror image relation, and a varactor diode arranged between the two square perforated metal patches; and
in the square resonant component, the varactor diodes in the perforated square resonant units in a same row are arranged in a same direction, and the varactor diodes in the perforated square resonant units in adjacent rows are arranged in opposite directions.

2. The tunable FSS structure according to claim 1, wherein the square perforated metal patches are each provided with three square holes, namely, a first square hole, a second square hole, and a third square hole; and the first square hole and the second square hole are symmetrically arranged on two sides of the third square hole.

3. The tunable FSS structure according to claim 2, wherein the first square hole comprises two parallel transverse edges and two parallel vertical edges;
the second square hole comprises two parallel transverse edges and two parallel vertical edges;
the third square hole comprises two parallel transverse edges and two parallel vertical edges;
one end of a first transverse edge of the third square hole is connected to one end of a first transverse edge of the first square hole, the other end of the first transverse edge of the third square hole is connected to one end of a first transverse edge of the second square hole and the first transverse edge of the third square hole, the first transverse edge of the first square hole and the first transverse edge of the second square hole are located on a same horizontal line;
one end of a second transverse edge of the third square hole is connected to one end of a second transverse edge of the first square hole, the other end of the second transverse edge of the third square hole is connected to one end of a second transverse edge of the second square hole, and the second transverse edge of the third square hole, the second transverse edge of the first square hole and the second transverse edge of the second square hole are located on a same horizontal line; and
a first vertical edge of the third square hole and a first vertical edge of the first square hole are the same, and a second vertical edge of the third square hole and a first vertical edge of the second square hole are the same.

4. The tunable FSS structure according to claim 3, wherein the square perforated metal patches each further comprise a first extended edge and a second extended edge;
the first extended edge is an edge passing through a first marking end to extend outward, and the second extended edge is an edge passing through a second marking end to extend outward;
the first marking end is the other end of the first transverse edge of the first square hole, and the second marking end is the other end of the first transverse edge of the second square hole; and
in the square resonant component, the perforated square resonant units in the same row are connected together through the first extended edge and the second extended edge, such that the varactor diodes in a same row are in parallel connection.

5. The tunable FSS structure according to claim 4, further comprising a first feed metal wire and a second feed metal wire, wherein
the first feed metal wire is connected to one end of a first marking extended edge in the perforated square resonant units in a first column of the matrix, and the second feed metal wire is connected to one end of a second marking extended edge in the perforated square resonant units in a last column of the matrix;
the perforated square resonant units each comprise a first square perforated metal patch and a second square perforated metal patch; when the perforated square resonant units are located in odd-numbered rows of the matrix, the first marking extended edge is a first extended edge of the first square perforated metal patch, and when the perforated square resonant units are located in even-numbered rows of the matrix, the first marking extended edge is a first extended edge of the second square perforated metal patch; when the perforated square resonant units are located in odd-numbered rows of the matrix, the second marking extended edge is a second extended edge of the second square perforated metal patch, and when the perforated square resonant units are located in even-numbered rows of the matrix, the second marking extended edge is a second extended edge of the first square perforated metal patch; and
in an operation process, when the varactor diodes have anodes connected to the first square perforated metal patch and cathodes connected to the second square perforated metal patch, when the first feed metal wire is connected to a positive pole of an external power supply, the second feed metal wire is connected to a negative pole of the external power supply, and when the varactor diodes have anodes connected to the second square perforated metal patch and cathodes connected to the first square perforated metal patch, when the first feed metal wire is connected to the negative pole of the external power supply, the second feed metal wire is connected to the positive pole of the external power supply.

6. The tunable FSS structure according to claim 3, wherein the transverse edges of the first square hole and the transverse edges of the second square hole are all 1 mm long; the transverse edges of the third square hole are 4 mm long; the vertical edges of the first square hole and the vertical edges of the second square hole are all 4.3 mm long; and the vertical edges of the third square hole are 3.8 mm long.

7. The tunable FSS structure according to claim 1, wherein the varactor diodes have a capacitance range of 0.3-2.22 pF; and the varactor diodes have an on-load voltage range of 0-20 V.

8. The tunable FSS structure according to claim 1, wherein the perforated square resonant units each have dimensions of 16 mm×10 mm, and the square perforated metal patches each have dimensions of 8 mm×4.6 mm.

9. The tunable FSS structure according to claim 1, wherein in the perforated square resonant units, every two of the square perforated metal patches have a gap of 0.4 mm, and the varactor diodes are located at the gaps.

10. The tunable FSS structure according to claim 1, wherein the dielectric substrate is an FR4 substrate, and has a thickness of 0.4 mm.
